(19) United States
(12) Patent Application Publication
(10) Pub. No.: US 2007/0045529 A1
(43) Pub. Date: Mar. 1, 2007

(54) Mass spectrometry data analysis engine

(76) Inventors: Libo Cao, Sunnyvale, CA (US); Christopher Janko, Redwood City, CA (US); Guoxiang Chen, Moorpark, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/329,536

(22) Filed: Jan. 11, 2006

Related U.S. Application Data
(60) Provisional application No. 60/711,083, filed on Aug. 23, 2005.

(51) Int. Cl. H01J 49/26

(52) U.S. Cl. 250/282

(57) ABSTRACT

A data processing engine for an automated mass spectrometry system is provided that identifies analyte and spike peak locations in spectral data based upon mass spectrometer tunings and solution identities. The data processing engine calculates analyte concentrations based upon spectral responses at the identified peak locations.

### RELATED APPLICATION

This application claims the benefit of U.S. Provisional Application No. 60/711,083, filed Aug. 23, 2005, the contents of which are incorporated by reference.

### BACKGROUND OF THE INVENTION

The present invention relates to mass spectrometry, and more particularly to a mass spectrometry data analysis engine.

Mass spectrometry is generally the technique of choice for measurement of parts per billion (ppb) and sub-ppb levels such as parts per trillion (ppt) of elements and compounds in solutions. For example, the present assignee, Metara, Inc., has developed an automated in-process mass spectrometry (IPMS) system that for the first time allows users such as semiconductor manufacturers to detect, identify, and quantify the chemistry of wet process baths and cleaning solutions. Unlike traditional mass spectrometry instruments, the IPMS technique is automated and requires no human intervention. In contrast, the use of traditional mass spectrometers such as an inductively-coupled-plasma mass spectrometer (ICP-MS) requires hands-on attention from highly-trained personnel.

The use of conventional mass spectrometry is typically “open loop” in that a calibration curve is first established by the users. In general, progressively concentrated (or diluted) solutions of the analyte of interest are processed through the mass spectrometer (MS) instrument and the results recorded. For example, a 10 ppm solution may be processed, then a 20 ppm solution, and so on. Having established this calibration curve, a user may then analyze the solution of interest. By comparing response from the analyte to the calibration curve, a user may determine the amount of the analyte. If, for example, the response lies halfway between the 10 ppm and 20 ppm calibration curve recordings, a quantification of 15 ppm may be assumed.

But mass spectrometers are prone to response shifts over time. Moreover, there may be response shifts caused by the difference between the matrices of the calibration standard and the sample. For example, if the acidic matrix shifts in composition, the calibration process must be repeated. These response shifts may be rapid, requiring frequent re-calibrations by experienced technicians. Thus, traditional mass spectrometry analysis was inappropriate for application requiring continuous and unattended operation such as in semiconductor manufacture. In contrast to traditional techniques, however, IPMS instruments are “closed loop” and thus do not suffer from response shifts.

In an IPMS instrument, a processor controls an automatic sampling of the solution of interest, spiking the sample with a calibration standard, ionizing the spiked sample, processing the ionized spiked sample through the mass spectrometer to produce a ratio response, and analyzing the ratio response to determine the amount of an analyte in the sample. Unlike prior art open loop techniques, response drifts are not a problem—the drift affects the spike and sample in the same fashion and is thus cancelled in the ratio response. Unlike the open loop MS technique discussed above, the addition of a known amount of spike to a sample “closes the loop” and provides accurate results. Thus, automated operation may be implemented without the necessity of manual intervention or recalibration. In addition, stable and reliable operation is assured by, in an embodiment, the use of atmospheric pressure ionization (API) such as electrospray to ionize the spiked sample. Moreover, the use of API preserves molecular species. Furthermore, the IPMS technique is applicable to the analysis of analytes in either trace or bulk concentrations.

Although the IPMS technique represents a significant advance, it faces challenges as well. For example, in a semiconductor manufacturing application, an IPMS tool may have to analyze process solutions having widely-different chemical compositions and properties. For example, SC1 is a basic solution including ammonium hydroxide whereas SC2 is a highly acidic solution including hydrochloric acid. The chemical composition of the solution being analyzed affects the resulting mass spectrum. For example, measuring an analyte concentration through analysis of its mass spectrum is complicated by the presence of “side peaks” which occur, for example, because the ions may become fragmented in the spectrometer. In addition, such side peaks result from reaction with other chemicals in the sample and/or species in the mass spectrometer. This fragmentation and reaction produces correspondingly lighter or heavier ions that overlap or interfere with the analyte spectral response. Moreover, neighboring peaks cause peak overlapping problems in the resulting spectrum. Instrument noise and sample contamination may further complicate the analyte concentration calculation. A variety of data processing techniques have been developed to process the mass spectrum so as to accurately characterize an analyte of interest despite such spectral affects. The spectral data is first smoothed and then deconvoluted to remove the effects of interfering side peaks. However, these techniques are specialized for a given solution/analyte composition. An IPMS tool configured with a particular data processing algorithm would be dedicated to the analysis of the solution/analyte composition corresponding to the algorithm.

Accordingly, there is a need in the art for improved IPMS tools that can automatically adjust their spectral analysis in response to the type of analyte being measured and the particular solution composition.

### SUMMARY

This section summarizes some features of the invention. Other features are described in the subsequent sections.

In accordance with an aspect of the invention, a computer-implemented method is provided. The method includes the acts of: providing a sample having a plurality of analytes of unknown concentrations; spiking the sample with a plurality of spikes corresponding to the analytes to form a mixture, the spikes having a known concentration; ionizing the mixture and analyzing the ionized mixture in a mass spectrometer to obtain sets of mass spectral data, each set of mass spectral data corresponding to a unique mass spectrometer tuning defining a corresponding mass window in the mass spectral data; for each set of mass spectral data: identifying analytes and corresponding spikes within the corresponding mass window; identifying theoretical peak locations for the identified analytes and corresponding spikes within the corresponding mass window; identifying peak locations in the mass spectral data corresponding to the theoretical peak locations; and based upon responses at the identified peak locations, calculating the unknown concentrations of the analytes using a ratio measurement.

The invention is not limited to the features and advantages described above. Other features are described below. The invention is defined by the appended claims.

### BRIEF DESCRIPTION OF THE DRAWINGS

FIG. 1 is a block diagram of a mass spectrometry system having a data processing engine according to an embodiment of the invention;

FIG. 2 is a flowchart of a data processing method according to an embodiment of the invention;

FIG. 3 is an exemplary mass spectrum; and

FIG. 4 illustrates peaks extracted from the mass spectrum of FIG. 3 using an appropriate de-convolution algorithm.

### DETAILED DESCRIPTION

Reference will now be made in detail to one or more embodiments of the invention. While the invention will be described with respect to these embodiments, it should be understood that the invention is not limited to any particular embodiment. On the contrary, the invention includes alternatives, modifications, and equivalents as may come within the spirit and scope of the appended claims. Furthermore, in the following description, numerous specific details are set forth to provide a thorough understanding of the invention. The invention may be practiced without some or all of these specific details. In other instances, well-known structures and principles of operation have not been described in detail to avoid obscuring the invention.

One embodiment of the present invention will now be described in detail. This embodiment analyzes solutions often used in the semiconductor industry for electroplating, etching, depositions, wafer cleaning, and possibly other applications. It will be appreciated, however, that this embodiment is merely exemplary such that the invention is not limited to the analysis of semiconductor processing solutions.

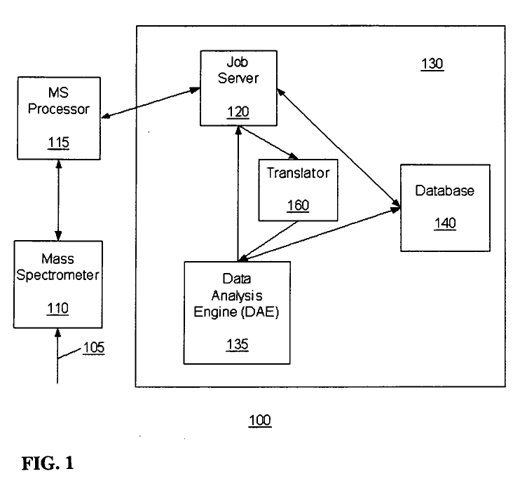

Turning now to FIG. 1, an IPMS system 100 is illustrated having at least one processor 130 configured with an embodiment of the data analysis engine (DAE) 135. Processor 130 is also configured with a job server 120 which functions as an automation engine, controlling the IPMS operations associated with a mass spectrometer (MS) 110. These operations are disclosed, for example, in U.S. Ser. No. 10/004,627, filed Dec. 4, 2001, U.S. Ser. No. 10/086,025, filed Feb. 28, 2002, and U.S. Ser. No. 10/094,394, filed Mar. 8, 2002, the contents of which are hereby incorporated by reference. For illustration clarity, the associated apparatus of an IPMS system, such as a sample extraction module are not illustrated. Job server 120 controls IPMS system 100 (through, for example, a mass spectrometer (MS) processor 115) to mix a known volume of spike with a known volume of sample. Because the concentration of the spike is also known, the concentration of an analyte in the sample may be determined from the raw mass spectral data after appropriate processing. The processing allows the formation of a ratio based upon the known amount of spike added to the sample. The nature of the spike depends upon the analyte. The spike may be an IDMS spike such that it alters a naturally occurring isotopic ratio for the analyte. Alternatively, the spike may be a chemical homologue of analyte in an internal standard approach. Regardless of the nature of the spike, the resulting ratio measurement cancels out drift and other inaccuracies, thereby enabling automated operation over lengthy periods of time. The apparatus for automatically drawing a sample, preparing a spike by dilution (if necessary), mixing the sample and prepared spike, and ionizing the resulting mixture to form ions 105 for processing by MS 110 are described in the above-mentioned applications but not shown in FIG. 1 for illustration clarity.

Data analysis engine 135 may receive resulting raw spectral data from MS 110 through an interface with job server 120. Spectral data may be considered to exist in an x,y type of format, where x represents the m/z value and y represents the peak value for the m/z value. The format of this data will depend upon the manufacturer of MS 110. To make data analysis engine 135 independent of a particular mass spectrometer, processor 130 includes a translator 160 that function as an interface between the data analysis engine and the raw mass spectral data. Translator 160 extracts the x,y data from raw spectral data provided by job server 120 and presents it in a common format to data analysis engine 135 such as in an XML format.

To make an IPMS system cost effective, it may be used to analyze a plurality of various process solutions. For example, the same IPMS system may be used to characterize the amount of analytes in SC1 (Standard Cleaning Solution 1), SC2 (Standard Cleaning Solution 2), UPW (Ultra Pure Water), and dilute HF. The analytes being characterized in each process solution may the same or may be unique to each solution. If the IPMS system were to spike for only one analyte during any given measurement cycle, the amount of time necessary to determine the concentrations of all the analytes of interest across the plurality of process solutions could become prohibitive. Thus, an IPMS system may be configured to spike each sample simultaneously for a plurality of analytes. The spike solution added to the sample may thus be a mixture of multiple spikes. For example, to characterize the chemistry of copper plating solution, the amounts of Cu, chloride, suppressor, accelerator, leveler, and their breakdown products are of interest. Each analyte has a corresponding spike. For example, if the accelerator comprises bis (3-sulfopropyl) disulfide (SPS), the spike may contain a known concentration of bis (2-sulfoethyl) disulfide (SES). In addition, the spike would contain a known concentration of a labeled polymer to characterize the amount of suppressor, and so on.

Given these plurality of spikes and analytes that may be present in the ionized mixture being analyzed by the mass spectrometer in an IPMS system, a variety of mass spectrometer tunings may be used. As known in the mass spectrometry arts, various settings such as capillary voltages, skimmer voltages, pulser voltages, and detector voltage levels comprise a mass spectrometer tuning. Each tuning is used to characterize a certain mass range. For example, one tuning may be used to characterize analytes of relatively low molecular weight whereas another tuning may be used to characterize analytes of higher molecular weight. The range of masses observable for a given tuning may be denoted as a mass window. The mass windows may be identified by an element within the window. For example, a Na mass window may have a mass range that includes Be, Na, Mg, and Al. Similarly, A K window may include K, Ca, and V. A Ni window may include Cr, Mn, Fe, Co, Ni, Cu, and Zn. A Ba window may include As, Se, Sr, Mo, Ag, Cd, Sn, Sb, and Ba. Finally, a Pb window may include Ti and Pb. Other mass windows may also be defined. As known in the arts, a mass spectrometer such as MS 110 will generally include a controller such as mass spectrometer (MS) processor 115. MS Processor 115 controls the particular tuning applied to MS 110. Thus, job server 120 interfaces with MS processor 115 to command a desired tuning (and hence mass window). It will be appreciated, however, that MS processor 115 is optional in that embodiments of the invention may be implemented wherein job server 120 controls the tunings for MS 110 directly rather than through MS processor 115.

In embodiments of the present invention, data analysis engine 135 queries a database 140 for information required to optimally analyze spectra associated with specific mass spectrometer tunings. Data files associated with specific tunings define the corresponding mass window(s) of interest. Because the analytes being measured may vary from one process solution to another, data analysis engine 135 may also query database 140 for the identity of the process solution being analyzed. Database 140 stores, for each solution and tuning, the identities of the analytes within the corresponding mass window and the also the identities of the corresponding spikes. Database 140 may provide data analysis engine 135 the corresponding data, for example, theoretical locations of the corresponding peaks for the analytes and spikes. Thus, data analysis engine 135 may identify the actual peaks of interest for a given mass spectrum.

The identity of the process solution is known because job server 120 (the automation engine) may control the apparatus for drawing the sample such that it drawn from a known solution type identified in database 140. In addition, job server 120 controls the spike preparation apparatus so that the appropriate spikes for particular analytes in the identified process solution are prepared. The m/z peaks for the analyte and the spike that will be analyzed within a given mass window will depend upon the mass spectrometer tuning. For example, voltage settings for items such as a mass detector within mass spectrometer 110 will affect the m/z peak location. Database 140 accounts for these affects in its prediction of the theoretical peak locations.

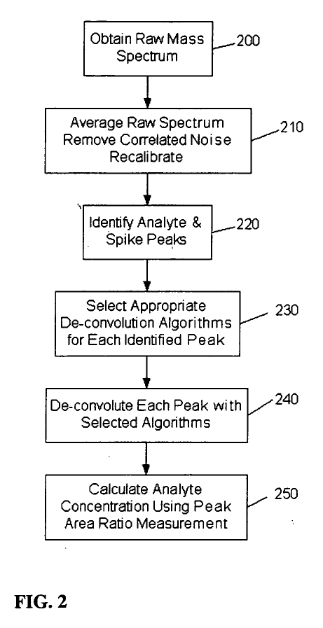

Turning now to FIG. 2, a flowchart for the data analysis engine operations is illustrated. In step 200, raw mass spectra are received by the data analysis engine from the translator as discussed with regard to FIG. 1. In step 210, the data analysis engine averages the translated raw spectra data, removes correlated noise, and may recalibrate the m/z locations of the averaged spectra.

Recalibration may be accomplished using “calibration peaks” corresponding to specific m/z locations in the averaged spectra. The identity of the calibrations peaks may be obtained based from database 140 as determined by the specific mass spectrometer tuning parameters and the process solution identity. For example, if the spectrum being processed corresponds to, for example, a sample of SC1 and a K mass window, the database may provide the corresponding calibration peak locations to the data analysis engine based upon expected known species within the K mass window. To recalibrate an averaged spectrum, the data analysis engine may identify the theoretical m/z location of calibration peaks corresponding to these known species. If the calibration peaks do not have the appropriate m/z ratio, the spectrum may be recalibrated so that the calibration peaks have the correct m/z ratio. This recalibration may comprise a mass shifting of the whole spectrum using, for example, a polynomial fitting algorithm responsive to the mass shift suggested by each calibration peak. Alternatively, other algorithms besides polynomial fitting may be used to calculate the average mass shift of the whole spectrum.

It will thus be appreciated that calibration peaks are chosen from peaks that are normally present in the process solution being sampled. The expected locations of the calibration peaks may be used to determine the error in m/z calibration for the collected data. This error may be due to mass spectrometer drift or other data acquisition error. Corrected or recalibrated m/z locations are determined by comparing actual calibration peak locations with theoretically expected m/z locations specified in database 140. To accurately complete the recalibration, the m/z error or mass shift is determined for a plurality of calibration peaks. A best fit mass shift may then be determined using, for example, a polynomial fitting algorithm. In addition, an auto-resolution calculation may be performed for the calibration peaks. The recalibrated m/z value for each analyte and spike peak of interest will thus be the sum of its actual m/z value and corresponding best fit mass shift value.

Referring again to FIG. 2, the data analysis engine retrieves the identities of peaks of interest from the database based upon the mass spectrometer tuning and process solution identity in a step 220. For example, should the process solution be SC1 and the mass spectrometer tuning correspond to a Ni mass window, the analytes may comprise Cu, Ni, Co, and Fe. Corresponding spikes to Cu, Ni and Fe may comprise conventional isotope dilution mass spectrometry (IDMS) spikes. For example, an IDMS spike for Cu would be a non-naturally occurring ratio of Cu₆₃ and Cu₆₅. Because Co is not amenable to such an analysis, its spike may comprise, for example, one of the isotopes in the Ni spike. Regardless of the identity of the analytes being characterized and their corresponding spikes, the database provides their theoretical peak locations to the data analysis engine. In addition, the database may provide appropriate peak processing algorithms, side peak locations, approximate resolution etc. The data analysis engine may then identify peaks in the spectral data corresponding to these theoretical peak locations. If appropriate, a smoothing and/or de-convolution algorithm may be selected for an identified peak in a step 230 so that the peak may then be deconvoluted in a step 240. As discussed previously, the de-convolution process mathematically removes side peak interference from a given identified peak. To prevent the de-convolution process from responding to noise, the spectrum may first be smoothed according to a variety of known smoothing algorithms. It will be appreciated that such de-convolution in step 240 may not be appropriate. For example, peaks corresponding to relatively high molecular weight species such as plating solution suppressor are so spread out that no de-convolution need be performed. Instead, only the baseline need be subtracted in such an analysis. In step 250, the data analysis engine may calculate the analyte concentrations based upon ratio measurements obtained from the identified peak areas.

Note the advantages of such an automated data analysis engine (as implemented in processor 130). Based upon the solution type and mass spectrometer tunings, the various analyte peaks and corresponding spike peaks are identified so that a broad number of solutions and corresponding analytes may be processed through IPMS system 100 with accuracy and without human intervention.

It will be appreciated that the particular type of de-convolution algorithm that is selected for in step 230 depends upon the solution being characterized. For example, three different de-convolution algorithms may be selected from. In a first peak de-convolution algorithm, a wavelet smoothing algorithm is applied first to the spectrum, followed by a Levenberg-Marquardt method to model and fit the peak. A baseline correction algorithm may then be performed before all the parameters (peak area, height, resolution etc.) of the peak are calculated. The first peak de-convolution method is found to be optimized algorithm for analytes of metal elements that are amenable to an IDMS analysis, plating solution accelerator, and leveler.

For the second peak de-convolution method, a wavelet smoothing method is applied, followed by a Levenberg-Marquardt method to model and fit the peak. Negative peaks are detected and baseline corrected. An isotopic de-convolution algorithm is also applied before the peak parameters to be calculated to resolve some over-lapped peaks caused by isotopic peaks. The second peak de-convolution method is optimal for the analysis of mono-isotopes (Na, Al, Mn, Co).

For the third peak de-convolution method, a Savitzky-Golay smoothing algorithm is applied following a baseline subtraction. Another wavelet smoothing algorithm is applied and a peak summation algorithm is used to calculate the total activity. The third peak de-convolution method is optimal for the analysis of type A suppressor.

As discussed above, some analyte and corresponding spikes have peaks that are not amenable to de-convolution such as for type B suppressor polymer used in semiconductor copper plating solution. A peak summation algorithm may be used to calculate the total activity of suppressor type B given the spread out nature of its spectral response. In addition, the baseline may be subtracted.

Having calculated the various analyte concentrations, the data analysis engine may alert users of any concentrations that are outside of expected norms. For example, a yellow light may be activated if an analyte concentration is approaching unacceptable levels. A red light may be activated if an analyte concentration is unacceptable. Conversely, a green light may be activated if the analyte concentrations are within acceptable limits. For feedback-based process control applications, an appropriate signal may be sent to an external controller that will then adjust the composition of the process solution accordingly.

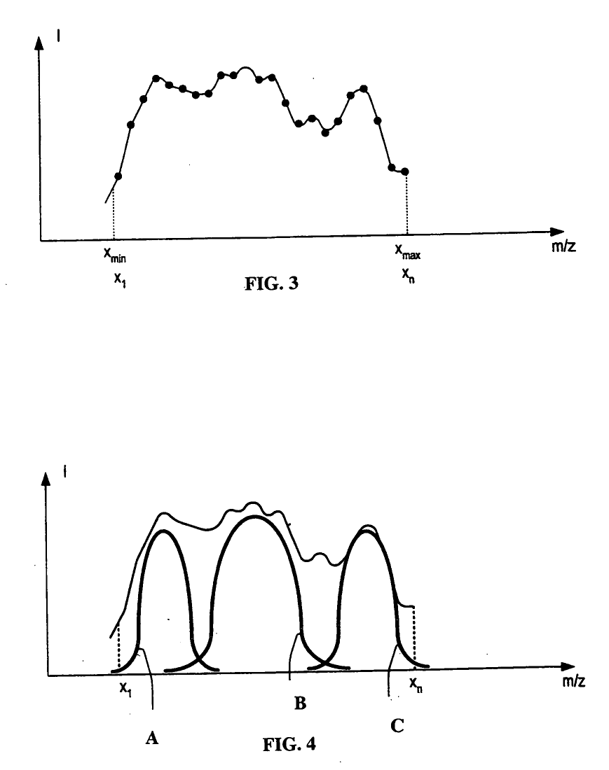

A graphical illustration of a mass spectrum having a mass window ranging from xₘᵢₙ to xₘₐₓ is shown in FIG. 3. Given the identity of the corresponding mass spectrometer tuning and sample source (solution ID), the data analysis engine may then perform the appropriate peak processing algorithm corresponding to analytes and spikes of interest within this mass window. Turning now to FIG. 4, it can be seen that three peaks (A, B, and C) have thus been deconvolved from the raw spectral data.

The above-described embodiments of the present invention are merely meant to be illustrative and not limiting. For example, the disclosed peak de-convolution algorithms are merely exemplary in that other types of peak de-convolution algorithms may be implemented by the data analysis engine. It will thus be obvious to those skilled in the art that various changes and modifications may be made without departing from this invention in its broader aspects. Therefore, the appended claims encompass all such changes and modifications as fall within the true spirit and scope of this invention.

We claim:

1. A computer-implemented method, the method comprising:
providing a sample having a plurality of analytes of unknown concentrations;
spiking the sample with a plurality of spikes corresponding to the analytes to form a mixture, the spikes having a known concentration;
ionizing the mixture and analyzing the ionized mixture in a mass spectrometer to obtain sets of mass spectral data, each set of mass spectral data corresponding to a unique mass spectrometer tuning defining a corresponding mass window in the mass spectral data;
for each set of mass spectral data:
identifying analytes and corresponding spikes within the corresponding mass window;
identifying theoretical peak locations for the identified analytes and corresponding spikes within the corresponding mass window;
identifying peak locations in the mass spectral data corresponding to the theoretical peak locations; and
based upon responses at the identified peak locations, calculating the unknown concentrations of the analytes using a ratio measurement.

2. The method of claim 1, further comprising:
averaging each set of mass spectral data to improve a quality of the responses in the mass spectral data.

3. The method of claim 1, wherein the identifying analytes and corresponding spikes act comprises retrieving the identities of the analytes and corresponding spikes from a data base.

4. The method of claim 1, further comprising:
based upon the identified analytes and corresponding spikes with the corresponding mass window:
selecting a smoothing algorithm for each set of mass spectral data; and
smoothing the set of mass spectral data with the selected smoothing algorithm.

5. The method of claim 4, further comprising:
for each smoothed set of mass spectral data:
selecting a de-convolution algorithm, and
deconvoluting the smoothed mass spectral data with the selected de-convolution algorithm to thereby improve the responses at the identified peak locations.

6. The method of claim 1, further comprising:
adjusting each set of mass spectral data for mass-to-charge calibration errors.

7. The method of claim 1, further comprising:
performing background subtraction for selected sets of mass spectral data.

8. The method of claim 1, further comprising:
subtracting correlated noise from selected sets of mass spectral data.

9. The method of claim 1, wherein the ratio measurement is an isotope dilution mass spectrometry (IDMS) ratio measurement.

10. The method of claim 1, wherein the ratio measurement is an internal standard ratio measurement.

11. The method of claim 1, further comprising:
comparing the calculated concentrations of the analytes to desired concentration levels; and
signaling a user if the comparisons indicate an analyte concentration is unacceptable.

12. The method of claim 1, wherein the sample is extracted from a process solution, the method further comprising:
comparing the calculated concentrations of the analytes to desired concentration levels; and
adjusting a composition of the process solution such that the analyte concentrations are within the desired concentration levels.

13. The method of claim 4, wherein the identified analyte is suppressor, and wherein the selected smoothing algorithm is a Savitzky-Golay smoothing algorithm.

14. The method of claim 1, wherein the identified analyte is suppressor type B, the method further comprising:
performing a baseline substraction on the set of mass spectral data; and
performing a TIC recalculation on the set of mass spectral data.

15. The method of claim 1, further comprising:
translating each set of mass spectral data into a universal data format independent of an identity of the mass spectrometer.

16. A method, comprising:
selecting a sample from a plurality of sample sources, the selected sample having a plurality of analytes of unknown concentrations;
spiking the sample with a plurality of spikes corresponding to the analytes to form a mixture, the spikes having a known concentration;
ionizing the mixture and analyzing the ionized mixture in a mass spectrometer to obtain sets of mass spectral data, each set of mass spectral data corresponding to a unique mass spectrometer tuning;
for each set of mass spectral data:
selecting a peak processing algorithm from a database based upon the mass spectrometer tuning and an identity of the sample source; and
performing the selected peak processing algorithm on the set of mass spectral data.

17. The method of claim 16, wherein a first peak processing algorithm in the database comprises a wavelet smoothing act followed by a Levenbert-Marquardt de-convolution algorithm.

18. The method of claim 16, further comprising:
translating each set of mass spectral data into a universal format independent of an identity of the mass spectrometer.
